(19) United States
(12) Patent Application Publication
(10) Pub. No.: US 2006/0189496 A1
(43) Pub. Date: Aug. 24, 2006

(54) Method for stripping cured paint with synthetic surfactants low in volatile organic compounds

(76) Inventor: Samuel L. Miles, Rochester Hills, MI (US)

Correspondence Address: Samuel L. Miles, 3143 Crooks Road, Rochester Hills, MI, 48309, US

(21) Appl. No.: 11/399,234

(22) Filed: Apr. 6, 2006

Related U.S. Application Data
(63) Continuation-in-part of application No. 10/605,559, filed on Oct. 8, 2003.

(51) Int. Cl. C11D 7/32

(52) U.S. Cl. 510/175

(57) ABSTRACT

A method of stripping cured paint from plastic, aluminum, brass, magnesium, galvanized steel, zinc die cast, and non-ferrous metal substrates, said method comprising: a) adding a stripping composition to a strip tank, consisting of a mixture of, not limited to, two synthetic detergent surface active agents, referenced in this invention as surfactants low in volatile organic compounds, specifically containing less than 50-percent by total weight or volume of any volatile organic compounds comprising 51% to 100% of the total weight or volume of the composition, with the remaining 0.5% to 49% balance consisting of additives; b) immersing said cured painted substrate in said strip tank containing said stripping composition; c) heating said stripping composition from 150 F. to 350 F for approximately 1-3 hours, wherein cured paint is removed from said substrate.

### SPECIFICATION

Method for Stripping Cured Paint with Synthetic Surfactants Low in Volatile Organic Compounds, this is a continuation in part for application Ser. No. 10/605,559, filed on Apr. 15, 2004, titled Method for Stripping Cured Paint from Plastic, Steel, Aluminum, Brass, Magnesium and Non-Ferrous Substrates with Synthetic Surfactants Low in Volatile Organic Compounds

### CROSS REFERENCES TO RELATED APPLICATIONS

U.S. Pat. No. 5,728,666 ISSUED ON MARCH 17, 1998, VITOMIR, CLASS 510/203. U.S. Pat. No. 5,894,854 ISSUED APRIL 20, 1999, MILES, CLASS 134/38. U.S. Pat. No. 6,130,192 ISSUED ON OCTOBER 10, 2000, VITOMIR, CLASS 510/202. U.S. Pat. No. 6,296,718 ISSUED ON OCTOBER 2, 2001, MILES, CLASS 134/19. U.S. Pat. No. 6,479,445 ISSUED ON NOVEMBER 12, 2002, MACHAC, JR. ET AL., CLASS 510/206. U.S. Pat. No. 6,608,012 ISSUED ON AUGUST 19, 2003, MACHAC, JR., ET AL., CLASS 510/212.

### BACKGROUND OF THE INVENTION

This invention is an environmentally sound method to strip cured paint from plastic, steel, aluminum, brass, magnesium and non-ferrous substrates. A paint stripping composition based on synthetic surfactants low in (VOCs) volatile organic compounds. More specifically, a paint stripping process invented to salvage reject or sometimes called rework painted production parts. The Industrial, Automotive, Appliance, Agricultural and Aircraft Industries paint interior and exterior parts to protect the substrates from corrosion and to enhance the cosmetic appearance to help market the finished product. Most paint finishing manufactures and paint finishing job shops have a zero tolerance for paint defects in the final product. The first pass paint finish many times will not pass the quality inspection. Up to 30% of first pass paint finishes are rejected by the quality inspectors and sent back to be stripped and reprocessed through paint. This invention provides a process that may be placed in the paint finishing plant or job shop to strip the cured paint completely from the rework parts for reprocess through paint in a like new condition. Prior art utilized many different compositions and methods to strip the cured paint. Prior art methods to strip cured paint include the following: High pH Caustic Hydroxides, low pH acid solutions that will attack soft base metal substrates such as aluminum, galvanized, brass, zinc and magnesium substrates. High temperature bake ovens operate in the 600 F to 1200 F range, often creating metal fatigue and adversely affecting the life of the part. Molten salt baths also operate at elevated temperatures up to 1000 F and the salt is corrosive. Organic solvents are also widely used to strip cured paint. The concern with solvent paint strip technologies is the (VOCs) volatile organic compounds that are released into our earth's atmosphere depleting the earth's protective ozone layer. Abrasives are also used to strip cured paint, many times adversely affecting the substrates surface. Abrasives do not remove cured paint from the parts interior or recessed areas as well as this invention utilizing a synthetic surfactant composition in a heated immersion application. Vitomir teaches, in patent (U.S. Pat. No. 6,130,192), compositions containing 9.9% benzyl alcohol, dimethyl sulfoxide and dipropylene glycol methyl ether. The benzyl alcohol and the dipropylene glycol methyl ether contain 100% volatile organic compounds. Sullivan teaches, in patent (U.S. Pat. No. 5,011,621), compositions containing n-methylpyrrolidone (NMP) and a co-solvent combined with 1-10% of a surfactant. The (NMP) found in Sullivan's composition is another example of a solvent containing 100% volatile organic compounds and the single surfactant is used primarily as an additive to improve solvency of the (NMP). These (VOCs) can be harmful to our earth's protective ozone layer. The inventor discovered a method to replace over 51% of the (VOC) containing solvents with at least two synthetic surfactants containing negligible amounts of (VOCs), with equal or improved stripping performance. Miles teaches, in patent (U.S. Pat. No. 6,296,718B1), the method and use of a composition low in (VOC) consisting an alkanolamine, a fatty acid and a single surfactant. Miles combines the preferred tall oil-fatty acid with the preferred triethanolamine to create a new triethanolamide compound and combines this new triethanolamide with the preferred single surfactant a diethanolamide to create a composition that in affect becomes a single triethanol-diethanolamide surfactant with no additional additives. Miles has since discovered that utilizing a composition consisting of a mixture of, not limited to, two synthetic detergent surface active agents, referenced in this invention as surfactants low in volatile organic compounds, specifically containing less than 50-percent by total weight or volume of any volatile organic compounds and the addition of an additive significantly improves stripping and allows the use of lower temperature ranges to strip the cured coating from the many different substrates.

### BRIEF SUMMARY OF THE INVENTION

The inventor discovered improved methods to chemically strip plastic, steel, aluminum, brass, magnesium, galvanized steel, zinc and non-ferrous substrates. This method is more environmentally desirable than past art paint strip methods. This invention is low in (VOCs) volatile organic compounds. The invention provides excellent penetration and solvency without the need for a high percentage of organic solvents. When heated in an immersion strip tank from 150 F. to 350 F. the composition effectively removes paint by dissolving and undercutting the cured paint film, normally within 1-hour. The composition will strip most current paint technologies including, not limited to the following: Electro-Deposition (E-Coat), Powder Coat Technologies, Solvent Borne, Water Borne and Clear Coat Technologies, Lacquer Technologies, Latex Technologies, Epoxy Coating Technologies and Urethane Coating Technologies. The method or process of use requires a heated hot strip tank capable of 150 F. to 350 F., however those skilled in the trade may utilize this invention at lower temperatures with longer stripping time. The invention, upon heating requires a good ventilation system and a mixer for agitation and uniform heat transfer. The invention is a unique composition to strip cured paint that exhibits low (VOCs) volatile organic compounds.

### DETAILED DESCRIPTION OF THE INVENTION

A method of stripping cured paint from plastic, aluminum, brass, magnesium, galvanized steel, zinc die cast, and non-ferrous metal substrates, said method comprising: a mixture of, not limited to, two synthetic detergent surface active agents, referenced in this invention as surfactants low in volatile organic compounds, specifically containing less than 50-percent by total weight or volume of any volatile organic compounds, selected from the group consisting; a) synthetic surfactants, non-ionic surfactants, anionic surfactants, cationic surfactants, amphoteric surfactants, acetate based surfactants, acetylene based, fluorosurfactants, solvent based surfactants, phosphate ester surfactants, acid pH based surfactants, alkaline pH based surfactants, neutral pH surfactants, sulfonic acid surfactants, phosphoric acid surfactants, fatty acid based surfactants, inorganic acid based surfactants, carboxylate based surfactants, alkylate based surfactants, alcohol based surfactants, nonylphenol surfactants, oxide-based surfactants, sulfur based surfactants, alkylphenol containing surfactants, ethoxylated surfactants, sulphonated surfactants, amine based surfactants, amide surfactants, glycol based surfactants and quaternary surfactants and surfactant blends thereof, comprising 51% to 100% of the total weight or volume of the composition, with the remaining 0.5%-49% balance consisting of additives selected by the group consisting; water, organic solvents, alcohols, aliphatic solvents, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, sulfates, nitrates, alkaline salts, acid salts, ethanol amines, peroxides, oxidizers, rust inhibitors, chelators, defoamers, surfactants and mixtures thereof; b) immersing said cured painted substrate in said strip tank containing said stripping composition; and c) heating said stripping composition from 150 F. to 350 F. for approximately 1-3 hours, wherein cured paint is removed from said substrate. In accordance with this invention, it is discovered that cured painted parts immersed in a mixture of at least two synthetic detergent surface active agents, referenced in this invention as surfactants low in volatile organic compounds, specifically containing less than 50-percent by total weight or volume of any volatile organic compounds and synthetic surfactant blends thereof, comprising 51% to 100% of the total weight or volume of the composition, with the remaining 0.5%-49% balance comprising additives at temperatures ranging from 150 F. to 350 F. degrees in an immersion hot strip tank for time ranging from 15 minutes to 3-hours will be completely stripped for reprocess through paint. This invention was tested for paint removal with present Industrial, Automotive, Wheel, Appliance, Agricultural and Aircraft Industry Paint Technologies. Paint tested was from the following manufactures: Dupont, PPG, Akzo Nobel, BASF, Red Dot, Morton, and Ferro. Paints tested were Powder, E-Coat, Automotive-(E-Coat, Base Coat/Clear Coat), Urethane, Lacquer and UV-Cured Base Coat. Results were observed after immersing parts with cured paint in to the composition at temperatures ranging from 150 F. to 350 F. degrees.

The time to completely strip parts for reprocess is provided below:

Anionic Surfactant Mixture at 200 F.

Mixture of 60% Tridecylbenzene Sulfonic Acid, 39% Dodecylbenezene Sulfonic Acid, 1% Glycolic Acid.

| Paint Technologies | Strip Time |
|---|---|
| E-Coat | 20 minutes |
| Powder Coat | 1-hour |
| Automotive | 1-hour |
| Lacquer | 30 minutes |
| Urethane-Fascia | 15 minutes |
| Urethane-Exterior Molding | 45 minutes |
| UV-Cured Base Coat | 3-hours |

Nonionic Surfactant Mixture at 350 F.

Mixture of 50% Alkylphenol-hydroxypolyoxyethylene (10 mol), 49%

Alkylphenol-hydroxypolyoxyethylene (4 mol), 1% Potassium Hydroxide.

| Paint Technologies | Strip Time |
|---|---|
| E-Coat | 15 minutes |
| Powder Coat | 1-hour |
| Automotive | 2-hours |
| Lacquer | 15 minutes |
| Clear Coat | 45 minutes |

Temperature is too high for plastic substrates.

Nonionic Surfactant Mixture at 300 F.

Mixture of 50% Ethoxylated Alcohol (C11 linear primary alcohol), 49% Ethoxylated Alcohol (C9 linear primary alcohol), 1% Triethanolamine.

| Paint Technologies | Strip Time |
|---|---|
| E-Coat | 30 minutes |
| Powder Coat | 1-hour |
| Automotive | 3-hours |
| Lacquer | 25 minutes |
| Clear Coat | 1-hour |

Temperature is too high for plastic substrates.

Cationic/Amphoteric Surfactant Mixture at 220 F.

Mixture of 25% Cationic Quaternary Ammonium, 25% Cationic Diamine, 25% Amphoteric Alkyl Amphocarboxylic Acid, 25% Glycolic Acid.

| Paint Technologies | Strip Time |
|---|---|
| E-Coat | 50 minutes |
| Powder Coat | 1-hour |
| Automotive | 1-hour |
| Lacquer | 50 minutes |
| Urethane-Fascia | 1-hour |
| Urethane-Exterior Molding | 1-hour |
| UV-Cured Base Coat | 3-hours |

What is claimed:

1. A method of stripping cured paint from plastic, aluminum, brass, magnesium, galvanized steel, zinc die cast, and non-ferrous metal substrates, said method comprising:
a) adding a stripping composition to a strip tank, said stripping composition consisting of a mixture of, not limited to, two synthetic detergent surface active agents, referenced in this invention as surfactants low in volatile organic compounds, specifically containing less than 50-percent by total weight or volume of any volatile organic compounds, selected from the group consisting; synthetic surfactants, non-ionic surfactants, anionic surfactants, cationic surfactants, amphoteric surfactants, acetate based surfactants, acetylene based, surfactants, fluorosurfactants, solvent based surfactants, phosphate ester surfactants, acid pH based surfactants, alkaline pH based surfactants, neutral pH surfactants, sulfonic acid surfactants, phosphoric acid surfactants, fatty acid based surfactants, inorganic acid based surfactants, carboxylate based surfactants, alkylate based surfactants, alcohol based surfactants, nonylphenol surfactants, oxide-based surfactants, sulfur based surfactants, alkylphenol containing surfactants, ethoxylated surfactants, sulphonated surfactants, amine based surfactants, amide surfactants, glycol based surfactants and quaternary surfactants and surfactant blends thereof, comprising 51% to 100% of the total weight or volume of the composition, with the remaining 0.5% to 49% balance consisting of additives selected by the group consisting; water, organic solvents, alcohols, aliphatic solvents, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, sulfates, nitrates, alkaline salts, acid salts, ethanol amines, peroxides, oxidizers, rust inhibitors, chelators, defoamers, surfactants and mixtures thereof;
b) immersing said cured painted substrate in said strip tank containing said stripping composition; and
c) heating said stripping composition in a range of 150 F to 350 F degrees for approximately 1-3 hours, wherein cured paint is removed from said substrate.

2. The method of claim 1, wherein said first synthetic detergent surface active agent, referenced in this invention as surfactant low in volatile organic compounds, specifically containing less than 50-percent by total weight or volume of any volatile organic compounds is in the range of 0.5-99.5 percent by weight.

3. The method of claim 1, wherein said second synthetic detergent surface active agent, referenced in this invention as surfactant low in volatile organic compounds, specifically containing less than 50-percent by total weight or volume of any volatile organic compounds is in the range of 0.5-99.5 percent by weight.

4. The method of claim 2, wherein said first synthetic detergent surface active agent, referenced in this invention as surfactant low in volatile organic compounds, specifically containing less than 50-percent by total weight or volume of any volatile organic compounds is in the range of 1-51 percent by weight.

5. The method of claim 3, wherein said second synthetic detergent surface active agent, referenced in this invention as surfactant low in volatile organic compounds, specifically containing less than 50-percent by total weight or volume of any volatile organic compounds is in the range of 1-51 percent by weight.

6. The method of claim 1, wherein said additives is in the range of 0.5-49 percent by weight or volume.

7. The method of claim 2, wherein said preferred synthetic detergent surface active agent, referenced in this invention as surfactant low in volatile organic compounds, specifically containing less than 50-percent by total weight or volume of any volatile organic compounds is dodecylbenzene sulfonic acid or a synthetic detergent surface active agent, referenced in this invention as surfactant low in volatile organic compounds, specifically containing less than 50-percent by total weight or volume of any volatile organic compounds selected from the group consisting; synthetic surfactants, non-ionic surfactants, anionic surfactants, cationic surfactants, amphoteric surfactants, acetate based surfactants, acetylene based surfactants, fluorosurfactants, solvent based surfactants, phosphate ester surfactants, acid pH based surfactants, alkaline pH based surfactants, neutral pH surfactants, sulfonic acid surfactants, phosphoric acid surfactants, fatty acid based surfactants, inorganic acid based surfactants, carboxylate based surfactants, alkylate based surfactants, alcohol based surfactants, nonylphenol surfactants, oxide-based surfactants, sulfur based surfactants, alkylphenol containing surfactants, ethoxylated surfactants, sulphonate based surfactants, amine based surfactants, amide surfactants, glycol based surfactants and quaternary surfactants and surfactant mixtures thereof.

8. The method of claim 3, wherein said preferred second synthetic detergent surface active agent, referenced in this invention as surfactant low in volatile organic compounds, specifically containing less than 50-percent by total weight or volume of any volatile organic compounds is tridecylbenzene sulfonic acid or a synthetic detergent surface active agent, referenced in this invention as surfactant low in volatile organic compounds, specifically containing less than 50-percent by total weight or volume of any volatile organic compounds selected from the group consisting; synthetic surfactants, non-ionic surfactants, anionic surfactants, cationic surfactants, amphoteric surfactants, acetate based surfactants, acetylene based surfactants, fluorosurfactants, solvent based surfactants, phosphate ester surfactants, acid pH based surfactants, alkaline pH based surfactants, neutral pH surfactants, sulfonic acid surfactants, phosphoric acid surfactants, fatty acid based surfactants, inorganic acid based surfactants, carboxylate based surfactants, alkylate based surfactants, alcohol based surfactants, nonylphenol surfactants, oxide-based surfactants, sulfur based surfactants, alkylphenol containing surfactants, ethoxylated surfactants, sulphonate based surfactants, amine based surfactants, amide surfactants, glycol based surfactants and quaternary surfactants and surfactant blends thereof.

9. The method of claim 6, wherein said preferred additive is glycolic acid or an additive selected from the group consisting; water, organic solvents, alcohols, aliphatic solvents, polar solvents, non-polar solvents, naphtha, oxygenated solvents, chlorinated solvents, acetones, ketones, acetates, terpene solvents, esters, acetylene solvents, glycols, ethers, propionate solvents, carbonates, aromatic solvents, kerosene, fatty acid based solvents, vegetable based solvents, acids, inorganic acids, organic acids, fatty acids, lactic acids, glycolic acids, alkaline hydroxides, alkaline silicates, phosphates, sulfates, nitrates, alkaline salts, acid salts, ethanol amines, peroxides, oxidizers, rust inhibitors, chelators, defoamers, surfactants and mixtures thereof; in the range of 0.5-49 percent by weight or volume.
